(19) United States
(12) Patent Application Publication
(10) Pub. No.: US 2002/0166640 A1
(43) Pub. Date: Nov. 14, 2002

(54) Device for gripping and handling bottles in a labelling machine and method of bottle filling/pressurising

(75) Inventors: Alessandro Caprara, Isola Della Scala (IT); Emanuele Mazzotta, Lunetta (IT)

Correspondence Address: THE FIRM OF KARL F ROSS, 5676 RIVERDALE AVENUE, PO BOX 900, RIVERDALE (BRONX), NY, 10471-0900, US

(73) Assignee: SIG ALFA S.p.A.

(21) Appl. No.: 10/125,682

(22) Filed: Apr. 18, 2002

(30) Foreign Application Priority Data
Apr. 20, 2001 (IT) MI2001A000838

(51) Int. Cl. B32B 31/00

(52) U.S. Cl. 156/556

(57) ABSTRACT

The device (1) for gripping and handling bottles (3) in a labelling machine comprises ;at least one body carrying a gripping member (2) of the neck of a bottle (3), control means (4) in rotation of said gripping member (2) and a centering member (5) of the bottle (3) with respect to said gripping member (2).

In the method of bottle filling/pressurising a stem (9) of a gripping and handling device (1) for bottles (3), provided with a passage (14) for the filling/pressurising gas for bottles (3), associates with an opening of the bottle (3), after that a tubular member (7) containing the stem (9) translates with respect to the stem (9) and opens an on-off valve (15), thereby causing the filling/pressurising of the bottle (3).

### DESCRIPTION

The present invention relates to a device for gripping and handling bottles in a labelling machine, and to a method of bottle filling/pressurising.

In particular, the device according to the finding can be used on machines for labelling plastic bottles.

Current labelling machines exhibit a carrousel structure, provided with a plurality of devices for gripping and handling bottles along their periphery.

Each device comprises a disk, associated through a guiding roller to a mechanical cam, and a member for centering the container relative to the disk.

The mechanical cam places the disks in rotation and thereby, the bottles resting on them, so that the bottles are suitably brought to the labelling units hat apply the labels.

However, such traditional devices has several disadvantages due to the fact that the system is not very flexible since the drives are mechanical.

In fact, when the bottle or the type of label being applied are changed, the device settings must be changed accordingly, so as to adapt them to the particular production or type of bottle being produced.

This implies that in the traditional devices, the mechanical cams arranged around the entire carrousel machine need to be replaced with different and suitably shaped cams.

Such operation causes even very long periods of inactivity.

Moreover, it is often necessary to replace also the devices feeding the bottles to the machine, such as for example screw conveyors and/or radial arms, thereby further increasing the periods of inactivity of the machine.

Moreover, the lower overall dimensions of traditional devices are always very large, since both the disks supporting the bottles from the base, and the cam, are arranged in the lower portion of the machine.

This hinders accessibility to the component parts of the labelling machine, as well as their cleaning.

Thus, the technical object of the present invention is that of eliminating the above prior art disadvantages by realising a device for gripping and handling bottles in a labelling machine, which should exhibit a very flexible operation.

Within the scope of this technical object, a purpose of the invention is to realize a device which should allow changing the settings to apply different labels or on different types of bottles, in a very quick and easy manner, so as to obtain very restricted dead times and ensure a very high productivity.

Another object of the invention is to realise a device which should not require replacing the mechanical cams with different cams and/or replacing the devices for feeding the containers to the machine, such as screw conveyors and/or radial arms.

A further object of the invention is to realise a device which should exhibit limited overall dimensions at its lower portion, so as to ensure good accessibility to the component parts of the machine and considerably facilitate their cleaning.

Last but not least, another object of the invention is to indicate a method of bottle filling/pressurising.

The technical object, as well as these and other objects, are achieved by a device for gripping and handling bottles in a labelling machine, characterised in that it comprises at least one boy carrying a member for gripping a bottleneck, control means in rotation of said gripping member, and a member for centering said bottle relative to said gripping member.

The invention also relates to a method of bottle filling/pressurising, characterised in that a stem of a bottle gripping and handling device, provided with a passage for the bottle filling/pressurising gas, associates with an opening of the bottle, after that a tubular member containing the stem translates with respect to the stem and opens an on-off valve, thereby causing the bottle filling/pressurising.

Moreover, further features of the present invention are defined in the following claims.

Advantageously, in the device according to the finding the control means actuates in rotation only the gripping member, and the centering member through the bottle. The other members, on the other hand, do not rotate.

The device is adapted for treating several types of bottles having different shape and size since all bottles exhibit similarities in their upper portion, in the proximity of the mouth, whereas they exhibit even considerable differences at the bottom.

Further features and advantages of the invention will appear more clearly from the description of a preferred but not exclusive embodiment of the bottle gripping and handling device in a labelling machine according to the finding, illustrated by way of 4 non-limiting example in the attached drawings. In such drawings:

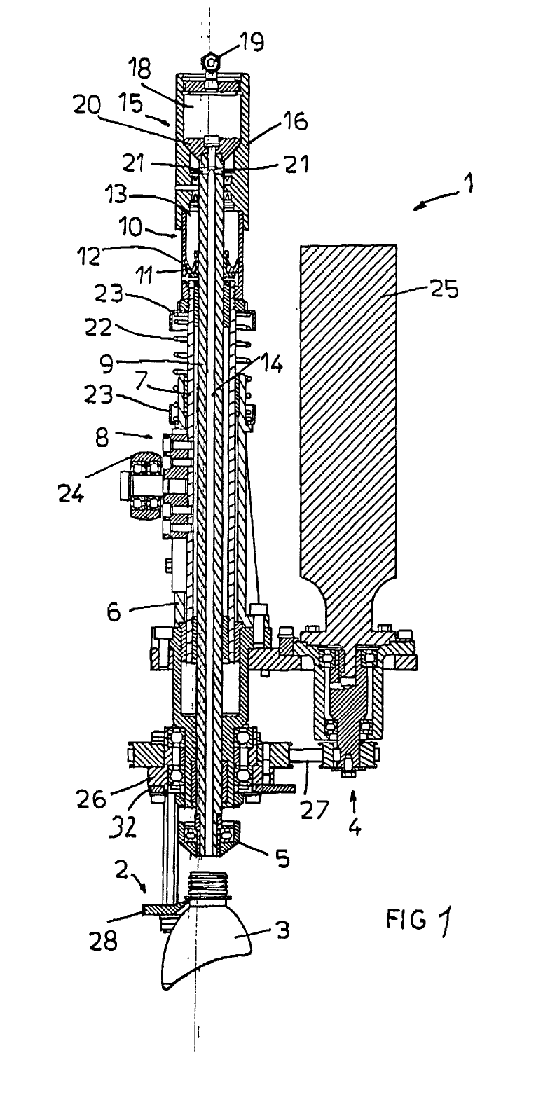

FIG. 1 shows a side elevation section of the device according to the finding;,

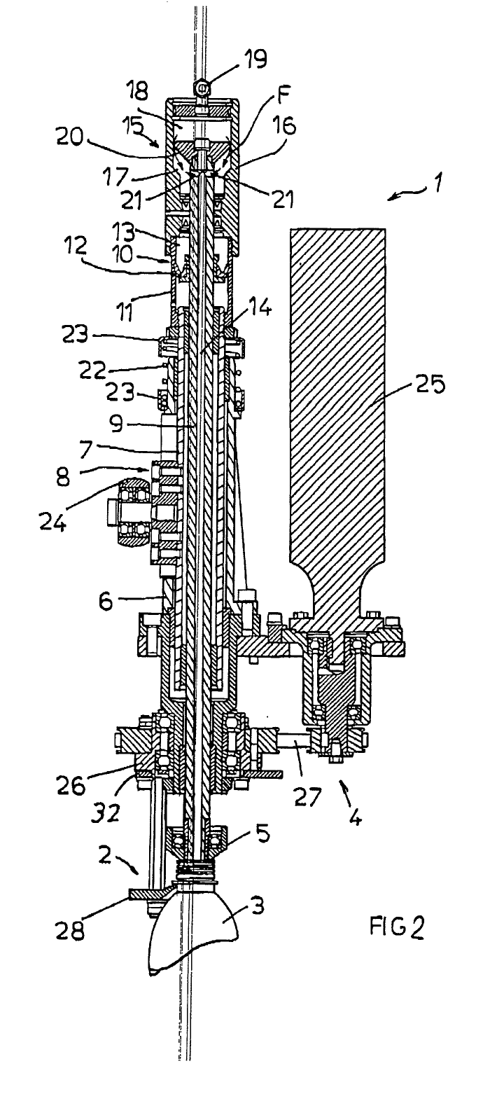

FIG. 2 shows a side elevation section of the device of the finding, in a different operating configuration;

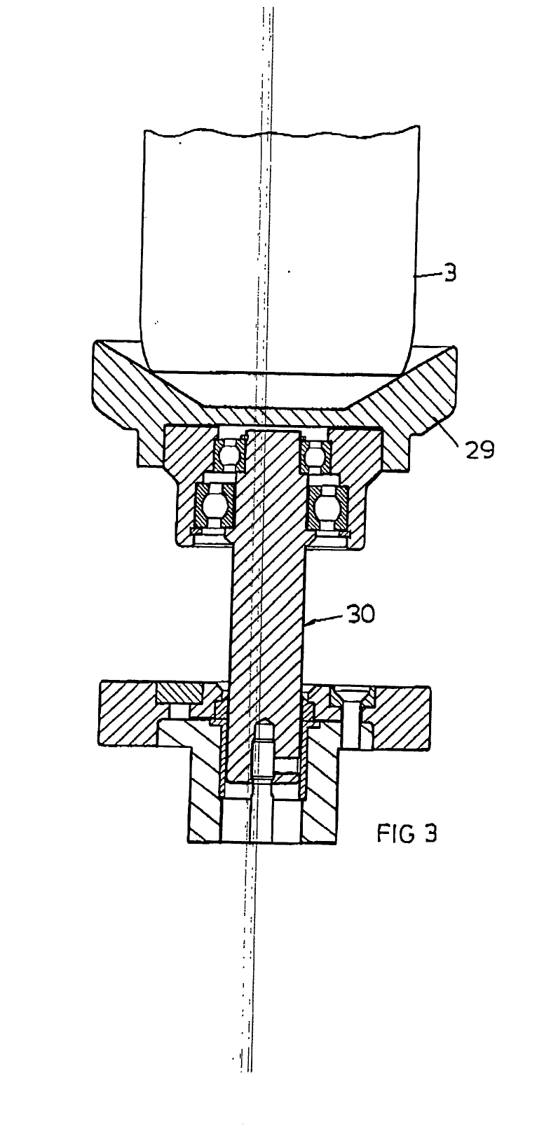

FIG. 3 shows an enlarged longitudinal section of a conical centering member associated to a bottle: and

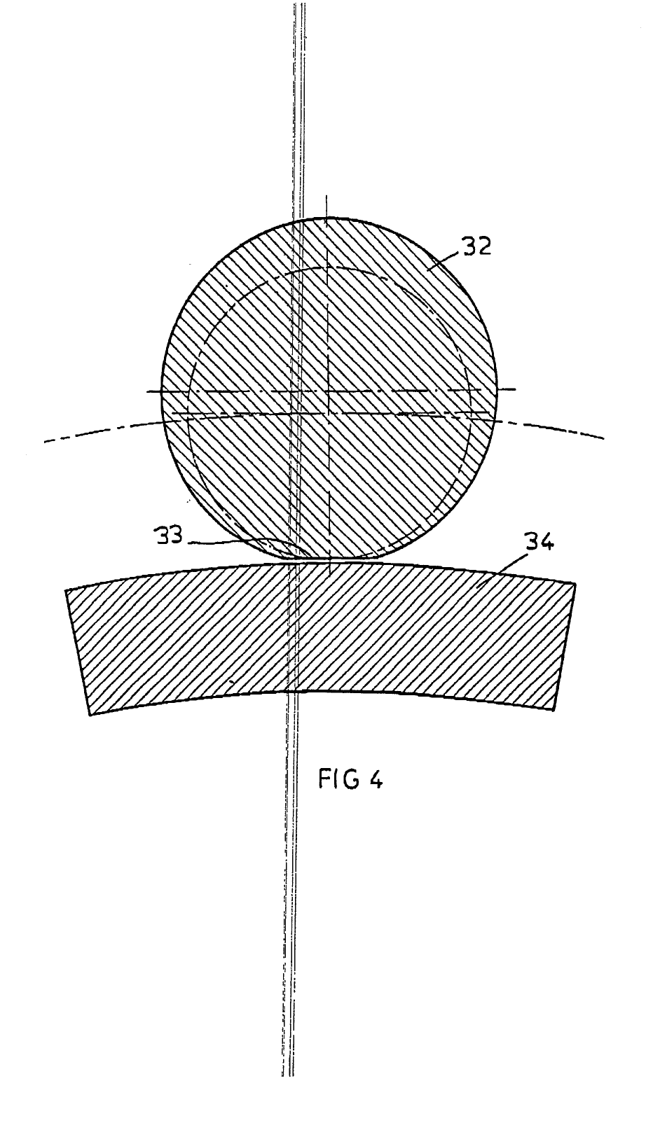

FIG. 4 shows an enlarged plan section of a member for synchronising the device according to the finding.

With reference to the above figures, there is shown a bottle gripping and handling device in a labelling machine, globally indicated with reference numeral 1.

Device 1 comprises a body: carrying a member 2 for gripping the neck of a bottle 3.

Bottles 3 are preferably led to device 1 by air and radial-type conveyors supporting them from the necks (enlarged external edge arranged at the thread),

In this way, the gripping member 2 can grip the bottles at their lower portion, that is, at the same necks, in a simple way and without any risk of overturning them.

Moreover, device 1 also comprises control means 4 that actuate in rotation the gripping member 2 and a centering member 5 of bottle 3 relative to the gripping member 2.

The gripping member 2 places bottle 3 in rotation and in turn, the latter places in rotation the centering member 5; in this way, the centering member 5 is placed in rotation by the same bottle 3.

The body of device 1 comprises an outside tubular member 6, which turnably supports the gripping member 2, into which an intermediate tubular member 7 provided with a guiding member 8, is slidingly connected.

A stem 9, carrying the centering member 5 at one end, is slidingly connected into the intermediate tubular member 7.

Moreover, first elastic means 10 is arranged between the intermediate tubular member 8 and stem 9.

The first elastic means 10 comprises an elastic gas member which in the example shown, is realised by a tubular body 11 coaxially crossed by stem 9 and delimited by two sealing gaskets.

In particular, the sealing gasket 12 that delimits the lower portion of the tubular member 11 (that is, towards the centering member 5) is contained into a seat of stem 9 and is thereby integral with stem 9.

In this way, a compensation chamber 13 containing compressible gas (for example, air) is formed into the tubular body 11, and the pressure existing into such compensation chamber presses the centering member 5 against bottle 3.

Stem 9 and the centering member 5 exhibit a passage 14 for introducing a gas under pressure into bottles 3.

At the end of stem 9 opposed to that carrying the centering member 5 there is associated a gas on-off valve 15.

Such on-off valve 15 comprises a body 16 provided with shoulder 17 and which form a pressurisation chamber 18 connected to a gas input flue through a union 19.

The flue (not shown) is provided with filters adapted for sterilising the gas; in this way, the portions of device 1 that come into contact with the gas are also sterile.

Moreover, device 1 also comprises an equipment (not shown) adapted for conveying sanitising fluid from the same union 19, adapted for sterilising the device circuit.

A washer 20 connected to the end of stem 9 slides into the pressurisation chamber.

Washer 20 is adapted for abutting against shoulder 17 to close valve 15.

Moreover, stem 9 exhibits thorough openings 21 for connecting passage 14 with the pressurisation chamber 18. Such passages 21 are obtained in the proximity of washer 20 at the side of stem 9 facing the centering member 5.

Moreover, device 1 comprises second elastic means 22, consisting of a spiral spring arranged between two stems 23, one integral with the outside tubular member 6 and the other integral with the intermediate tubular member 7.

Such spring 22 opposes the vertical motion of the guiding member 8.

The guiding member 6 comprises a roller 24 slidingly associated to a cam (not shown).

The control means 4 comprises an electric motor 25 preferably of the brushless type or other servomotor, controlled by a electronic device.

Motor 25 is connected to the outside tubular member 6; moreover, as shown, motor 25 and the outside tubular member 6 exhibit substantially parallel axes.

In this way, a very compact structure is obtained.

Moreover, the control means 4 comprises a support 26 integrally carrying the gripping member 2, turnably connected to the outside tubular member 6.

Support 26 is connected to motor 25 by flexible connection means 27, such as a belt.

In a preferred embodiment, the gripping member 2 comprises a fork 28 adapted for gripping a protruding edge, or neck, of bottles 3.

Moreover, in a different embodiment device 1 also exhibits a conical centering member 29 turnably neutral, to which bottle 3 is associated at a lower portion.

The conical centering member 29 prevents the misalignment of bottle 3 with the axis of stem 9.

In a preferred embodiment of the device, the conical centering member 29 is connected to a support 30 exhibiting at least one portion that can substantially vertically translate based on the size of bottle 3.

Support 30 starts after bottle 3 has come into contact with the centering member 5.

Thus, in the practice, a first centering is carried out on the upper portion of the bottle which also ensures the contact between bottle and device, and then a lower centering is carried out as well.

In the example shown, the conical centering member is connected to a stem of a vertically movable gas or hydraulic cylinder.

Moreover, in a preferred embodiment, device 1 comprises a synchronisation member 32, that is a safety element and allows synchronising the motion of the gripping means 2 with respect to the radial-type conveyors for both feeding and releasing the bottles.

In the practice, upon assembly, it is not necessary to synchronise the gripping means with the radial-type conveyors since such operation is carried out by the synchronisation member 32 when the labelling machine is actuated (for example, very slowly and without bottles).

Moreover, during the operation of the labelling machine, the synchronisation member 32 prevents device 1 from losing synchronisation with the radial-type conveyors.

The synchronisation 32 comprises a circular plate provided with a flattened portion 33.

Plate 32 is mounted eccentrically on support 26 and exhibits its flattened portion 33 associable to cams 34.

Cams 34 are supported by radial-type conveyor for feeding the bottles and the other is supported by the radial-type discharge conveyor.

As it can be seen in the figures, when the flattened portion 33 is not associated to cam 34, plate 32 rotates carrying portion 33 at plate 34 and synchronising the gripping means 2 with the radial-type conveyors

The operation of the device for gripping and handling bottles in a labelling machine according to the invention is clear from what described and illustrated, In particular, it is substantially as follows.

Air conveyors carry the bottles at the radial-type conveyors, which bring the bottles to the gripping member 2, which grips them.

Then, the guiding member 8 (guided by a mechanical cam, not shown) makes the intermediate tubular member 7 translate, along with stem 9 (cue to the pressure in the compensation chamber 13).

Stem 9 carries the centering member 5 onto the opening of bottle 3 and locks up; on the other hand, since the intermediate tubular member is pushed by the guiding member 6, it further translates and slides with respect to stem 9, making the volume of the compensation chamber 13 decrease.

The centering member 5 is kept against bottle 3 by the pressure existing in chamber 13 and, at the same time, bottle 3 is supported by the gripping member 2 at the neck.

Bottle 3 thus remains locked and centred between members 2 and 5.

The translation of the intermediate tubular member 7 when stem 9 is fixed causes valve 15 to open.

In fact, the washer slide in the pressurisation chamber 18 thereby moving away from shoulder 27 and allowing the gas flow, as indicated by arrows F.

On the other hand, when bottle 3 is not present, stem 9 continues to go down along with the tubular member 7 and valve 15 does not open.

The gas is thus introduced through the openings 21 into passage 14 and it is introduced into bottle 3, making it stiff and allowing labelling.

Motor 25 places support 26 in rotation, and then, the gripping member 2 according to settings (for example, via software) on the control circuits of the same motor 25.

Device I is very flexible since the bottle rotation is controlled by motor 25 and can Thus be changed in a very simple and quick way.

On the other hand, the guiding member 8, that acts on a cam, does not restrict the device flexibility since it only controls the translation of the inside tubular member 7 and of stem 9.

In the practice, the guiding member 8 controls the gripping and release steps of bottle 3 that are common for all bottle formats.

Thus, guide 8 can be used without the need of replacing the cat for several bottle shapes and sizes.

The present invention also refers to a method of bottle filling/pressurising, wherein a stem of device 1, provided with passage 14 for the gas for filling/pressurising bottle 3, is associated to an opening of bottle 3.

Afterwards, the intermediate tubular member 7 containing stem 9 translates with respect to stem 9 and opens an on-off valve 15, thereby filling/pressurising bottle 3.

In the practise, it has been proved that the device for gripping and handling bottles in a labelling machine according to the invention is particularly advantageous since it is very flexible.

The device for gripping and handling bottles in a labelling machine thus conceived can be subject to several changes and variants, all falling within the scope of the inventive idea; moreover, all details can be replaced with other technically equivalent ones.

In the practice, the materials used, as well as the sizes, can be of any type according to the requirements and to the prior art.

1. Device (l) for gripping and handling bottles (3) in a labelling machine, characterised in that it comprises at least one body carrying a gripping member (2) of the neck of a bottle (3), control means (4) in rotation of said gripping member (2) and a centering member (5) of the bottle (3) with respect to said gripping member (2).

2. Device (1) according to claim 1, characterised in that said centering member (5) is placed in rotation by said bottle (3).

3. Device (1) according to one or more of the previous claims, characterised in that said body comprises an outside tubular member (6), that turnably supports said gripping member (2), into which there is slidingly connected an intermediate tubular member (7) provided with a guiding member (B), into said intermediate tubular member there being slidingly connected a stem (9) carrying said centering member (5), where between said intermediate tubular member (7) and said stem (9) there is arranged first elastic means (10).

4. Device (1) according to one or more of the previous claims, characterised in that said first elastic means (10) comprises an elastic gas member.

5. Device (1) according to one or more of the previous claims, characterised in that said elastic gas member (10) comprises a tubular body (11) crossed by said stem (9) and delimited by two sealing gaskets (12), where a sealing gasket (12) delimiting the lower portion of said tubular body (11) is supported by said stem (9).

6. Device (1) according to one or more of the previous claims, characterised in that said stem (9) and/or said centering member (5) exhibit a passage (14) for introducing gas under pressure into said bottled (3).

7. Device (1) according to one or more of the previous claims, characterised in that a gas on-off valve (15) is associated to an end of said stem (9).

8. Device (1) according to one or more of the previous claims, characterised in that said on-off valve (15) comprises a body (16) provided with an inside shoulder (17) that forms a pressurisation chamber (18) inside which there slides a washer (20) connected to an end of said stem (9), said washer (20) being adapted for abutting Against said shoulder (17) for closing said on-off valve (15) and said stem (9) exhibiting thorough openings (21) connecting said passage (14) with said pressurisation chamber (18).

9. Device (1) according to one or more of the previous claims, characterised in that it comprises second elastic means (22) arranged between said outside tubular member (6) and said intermediate tubular member (7).

10. Device (i) according to one or more of the previous claims, characterised in that said guiding member (8) comprises a roller (24) slidingly associated to a cam.

11. Device (1) according to one or more of the previous claims, characterised in that said control means (4) comprises an electric motor (25) controlled by an electronic device.

12. Device (1) according to one or more of the previous claims, characterised in that said motor (25) is connected to said outside tubular member (6), and in that said motor (25) and said outside tubular member (6) exhibit a substantially parallel axis.

13. Device (1) according to one or more of the previous claims, characterised in that said control means (4) comprises a support (26), that integrally carries said gripping member (2), turnably connected to said outside tubular member (6), said support (26) being connected to said motor (25) through flexible connection means (27).

14. Device (1) according to one or more of the previous claims, characterised in that said gripping member (2) comprises a fork (28) adapted for gripping a protruding edge of said bottles (3).

15. Device (1) according to one or more of the previous claims, characterised in that comprises a centering member (29) turnably neutral, to which said bottles (3) can be associated at a lower portion.

16. Device (1) according, to one or more of the previous claims, characterised in that said centering member (29) is connected to a support (30) exhibiting at least one portion that can be substantially vertically translated.

17. Device (1) according to one or more of the previous claims, characterised in that it comprises a synchronisation member (32), adapted for synchronising the motion of said gripping members (2) with respect to radial-type conveyors for feeding and/or releasing the bottles.

18. Device (1) according to one or more of the previous claims, characterised in that said synchronisation member (32) comprises a circular plate provided with a flattened portion (33), wherein said flattened portion (33) can be associated to a cam 34 supported by said radial-type conveyor for feeding an/or releasing said bottles.

19. Method of bottle filling/pressurising, characterised in that a stem (9) of a device (1) for gripping and handling bottles (3), provided with a passage (14) for the gad for filling/pressurising the bottle (3), is associated to an opening of the bottle (3), then to a tubular member (7) containing the stem (9), translates with respect to the stem (9) and opens an on-off valve (15), thereby causing the filling/pressurisation of the bottle (3).

20. Device (1) of gripping and handling bottles in a labelling machine, and method for filling/pressurising bottles (3), as described and claimed.
